(19) United States
(12) Patent Application Publication
(10) Pub. No.: US 2017/0004723 A1
(43) Pub. Date: Jan. 5, 2017

(54) IDENTIFYING EVIDENCE OF JUSTIFICATION AND EXPLANATION SKILLS IN COMPUTER AUTOMATED SCORING

(71) Applicant: ACT, INC., Iowa City, IA (US)

(72) Inventors: Benjamin Marsh, Iowa City, IA (US); Kenneth Mullen, Iowa City, IA (US)

(21) Appl. No.: 15/198,249

(22) Filed: Jun. 30, 2016

Related U.S. Application Data
(60) Provisional application No. 62/186,943, filed on Jun. 30, 2015.

(51) Int. Cl. G09B 7/02; G09B 19/02

(52) U.S. Cl. CPC G09B 7/02; G09B 19/025

(57) ABSTRACT

Methods and systems for identifying justification and explanation skills in computer automated scoring of examinee responses by a computer automated scoring criteria that analyzes a response to a prompt, identifies evidence of justification and explanation skills in the response, and outputs an assessment summary. A quick and efficient measurement method of an examinee's justification and explanation skills in mathematical and other constructive response categories where nearly immediate feedback is preferred.

### CROSS-REFERENCE TO RELATED APPLICATIONS

This application claims priority under 35 U.S.C. §119 of a provisional application Ser. No. 62/186,943, filed Jun. 30, 2015, which is hereby incorporated by reference in its entirety.

### FIELD OF THE DISCLOSURE

The present disclosure relates generally to methods and systems for identifying evidence of justification and explanation skills in computer automated scoring of examinee responses; and using the identification of evidence to produce scores, summaries, comments, and other feedback (collectively referred to as reports), wherein the reports optionally can include annotated versions of examinee responses that identify particular evidence within the examinee responses.

### BACKGROUND OF THE DISCLOSURE

Historically, analyzing examinee responses to identify evidence of justification and explanation skills has been time-consuming and costly. In addition, some or all of the examinee responses need to be reviewed by a second or third rater within the established plans for assuring consistency and accuracy. This adds to the time, and added time results in added costs. Therefore, there is a need for computer automated scoring methods that provide nearly immediate evaluation of student responses in a cost-efficient manner and quickly and efficiently find and report evidence of justification and explanation skills in examinee responses.

### SUMMARY OF THE DISCLOSURE

The present disclosure provides methods and systems executing on one or more computing devices for identifying evidence of justification and explanation skills in examinee responses and reporting evidence of justification and explanation skills in examinee responses. The computing device can access, store, and transmit via transitory computer readable media, non-transitory computer readable media, and electronic transmission corridors: examinee tasks (items), examinee responses, reference sets of examinee responses, criteria about identifying evidence of justification and explanation skills, criteria and instructions for reporting, one or more generated reports, and programming instructions.

Methods and systems of the present disclosure executing on one or more computing devices obtain one or more responses from one or more examinees for identifying one or more features of those responses that represent evidence of justification and explanation skills. The one or more computing devices can be configured with read and write access to a non-transitory computer readable medium for accessing one or more test items with the one or more computing devices. The one or more test items are administered to an examinee and a response to the one or more test items is acquired. A set of criteria can be accessed with the one or more computing devices and applied to the response for identifying one or more types of evidence of justification and explanation skills within the responses to the one or more test items. A representation of the one or more types of evidence of justification and explanation skills contained in the response can be produced. Also, by accessing with the one or more computing devices one or more reporting algorithms, the representation of the one or more types of evidence of justification and explanation skills can be processed. The one or more reporting algorithms can also be applied to the representation of the one or more types of evidence and explanation skills. A report can be transmitted to one or more recipients.

Methods and systems of the present disclosure, executing on a computing device, can also be configured to identify evidence of justification and explanation skills in computer automated scoring of examinee responses. A computing device having a non-transitory computer readable medium can access one or more dimensions for measuring evidence of an examinee's justification and explanation skills, including accessing one or more reference sets (also known as example sets) defining, at least in part, a response characteristic associated with the evidence of the examinee's justification and explanation skills, and accessing one or more scoring metrics associated with the one or more dimensions for rating the evidence from the examinee's justification and explanation skills. Test items can also be stored on a non-transitory computer readable medium. By administering to an examinee on the computing device the one or more test items and receiving at the computing device examinee responses to the one or more test items, a comparison of the examinee response to the one or more test items with the one or more reference sets can be performed on the computing device. The computing device can output scoring metrics for the examinee response to the one or more test items. An output can include a listing of one or more features from the examinee response that is identified as evidence of the examinee's justification and explanation skills.

### BRIEF DESCRIPTION OF THE DRAWINGS

FIG. 1A is a pictorial representation of a flow chart in accordance with an illustrative embodiment of the present disclosure.

FIG. 1B is a pictorial representation of a flow chart in accordance with another illustrative embodiment of the present disclosure.

FIG. 2 is a pictorial representation of a flow chart in accordance with yet another illustrative embodiment of the present disclosure.

FIG. 3 is a pictorial representation of a justification evidence flow chart in accordance with an illustrative embodiment of the present disclosure.

FIG. 4 is a pictorial representation of a block diagram providing an overview of a method and system of the present disclosure in accordance with an illustrative embodiment;

FIG. 5 is a pictorial representation of a flowchart for a method and system of the present disclosure in accordance with another illustrative embodiment;

FIG. 6 is a pictorial representation of a communications environment in which the embodiments of the present disclosure may be implemented; and

FIG. 7 is a pictorial representation of block diagram for a computer network and system in which the embodiments of the present disclosure may be implemented.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The present disclosure provides for methods and systems for identifying evidence of justification and explanation skills in one or more examinee responses. For example, methods and systems of the present disclosure executing on a computing device analyze responses to one or more prompts (e.g., test items). The response and/or prompts can be written, oral, or based on some other mode. Responses can be sets of responses from the same person, class, or other grouping. Features in a response representing evidence of justification and explanation skills are identified. Analysis of the evidence can be used to provide feedback to students, parents, teachers, human scorers/graders, or others in the form of annotated representations of the responses, summaries of the one or more response characteristics, scores and other modes.

The present disclosure also provides methods and systems executing on a computing device for identifying evidence of justification and explanation skills in examinee responses and reports evidence of justification and explanation skills in examinee responses. The computing device can access, store, and transmit via transitory computer readable media, non-transitory computer readable media, and electronic transmission corridors, one or more of examinee tasks (items), examinee responses, reference sets of examinee responses, criteria about identifying evidence of justification and explanation skills, criteria and instructions for reporting, one or more generated reports, and/or programming instructions.

Methods and systems of the present disclosure executing on one or more computing devices can obtain one or more responses from one or more examinees for identifying one or more features of those responses that represent evidence of justification and explanation skills. The one or more computing devices can be configured with read and write access to a non-transitory computer readable medium for accessing one or more test items with the one or more computing devices. The one or more test items are administered to an examinee and a response to the one or more test items is acquired. A set of criteria can be accessed with the one or more computing devices and applied to the response for identifying one or more types of evidence of justification and explanation skills within the responses to the one or more test items. A representation of the one or more types of evidence of justification and explanation skills contained in the response can be produced. Also, by accessing with the one or more computing devices one or more reporting algorithms, the representation of the one or more types of evidence of justification and explanation skills can be processed. The one or more reporting algorithms can also be applied to the representation of the one or more types of evidence and explanation skills. One or more reports can be transmitted to one or more recipients.

Embodiments of the present disclosure contemplate use of the methods and systems herein disclosed to aid in flagging test items scoring outside of the normal score patterns. Other embodiments of the present disclosure include processing several responses by the same examinee to identify evidence of justification and explanation skills in the several responses. Still other embodiments contemplate taking one test item and all of the responses for the one test item and reporting on evidence of justification and explanation skills for all the responses taken together. In yet further embodiments, a batch of justification and explanation skills may be processed together using justification and explanation analytical criteria for identifying them. Some of the criteria can be configured for identifying a single justification and explanation skill in the batch and some of the criteria can be configured for identifying a group of justification and explanation skills.

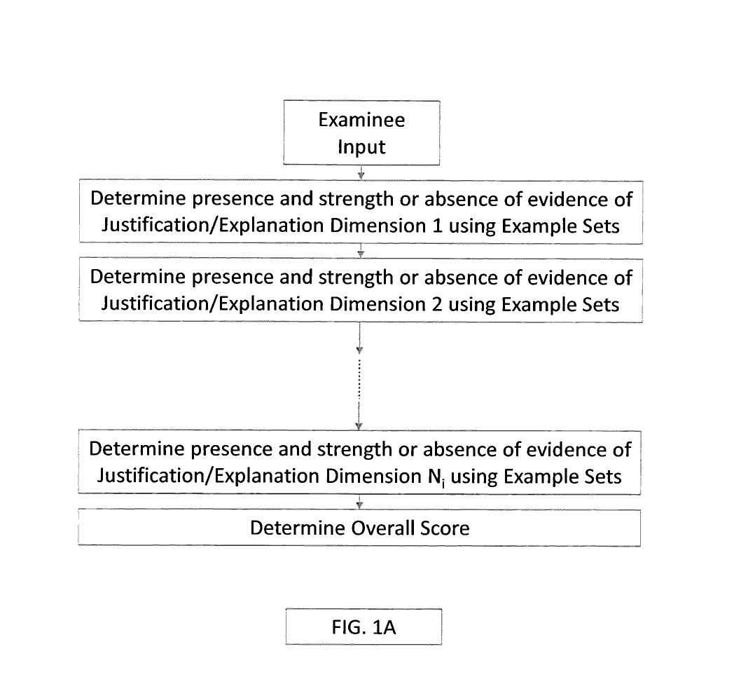

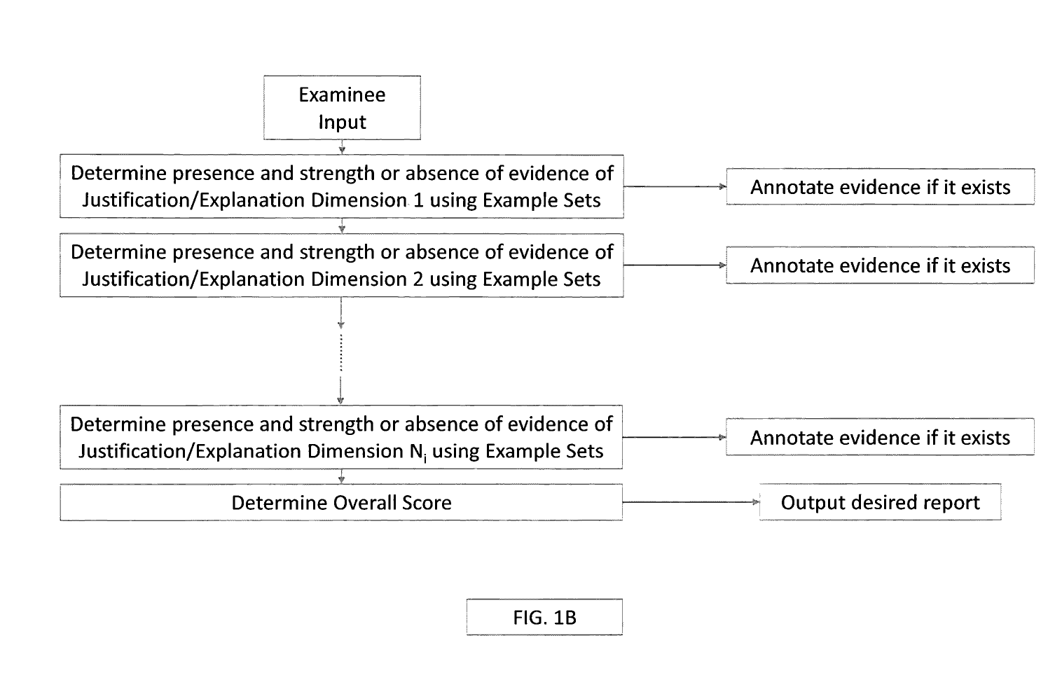

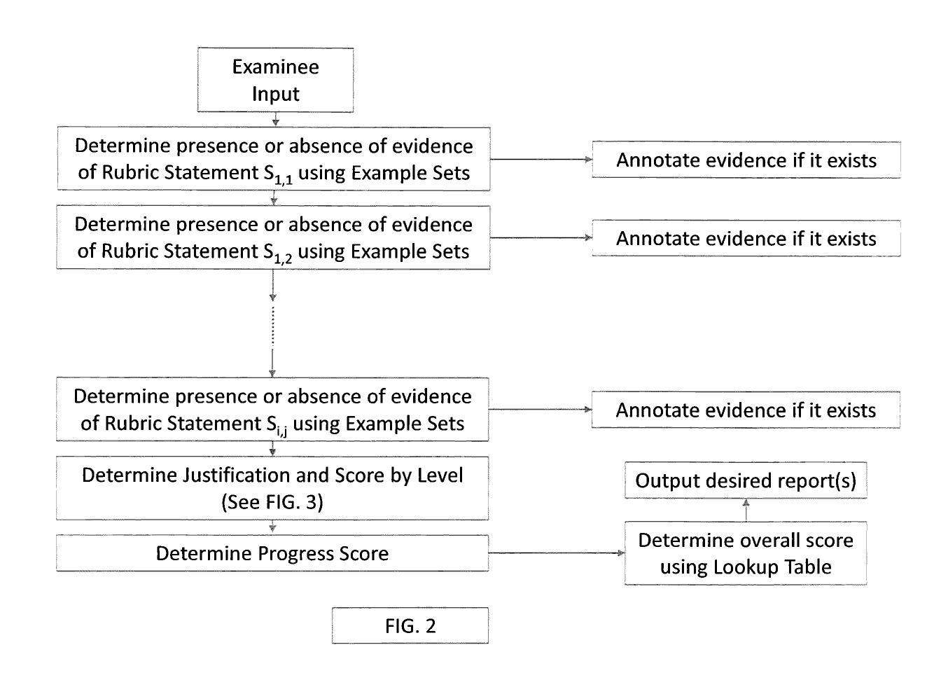

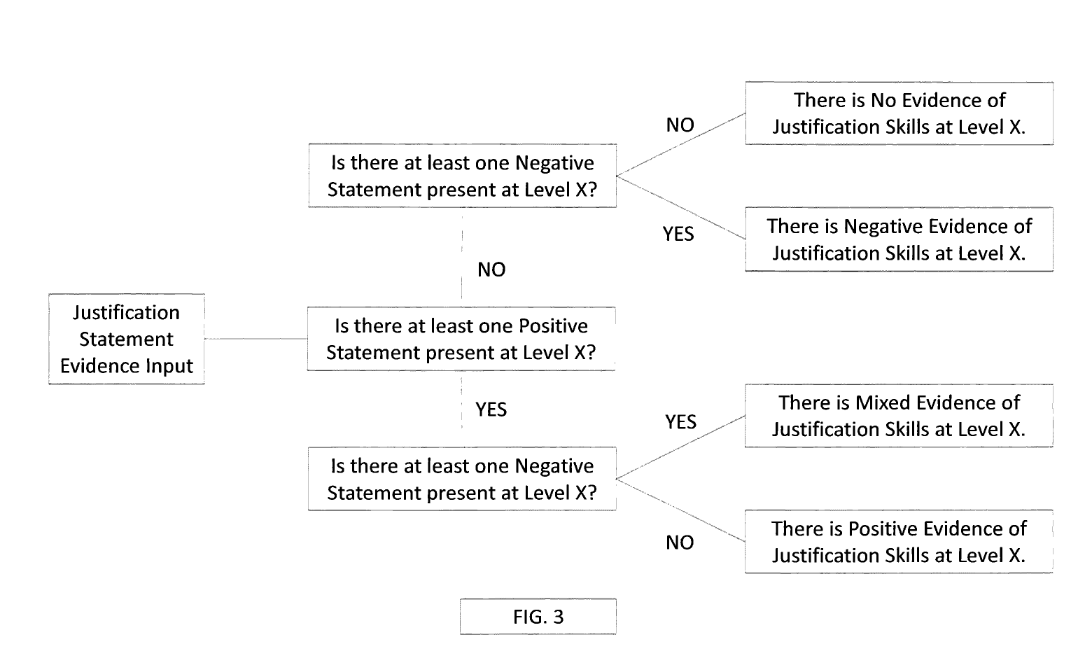

A pictorial representation of at least one embodiment in accordance with the methods and systems of the present disclosure is shown in FIG. 1A. As shown, an examinee presented with one or test items on a computing device provides a response or provides input to a prompt. The test items can be constructed response test items covering a variety of domains, including but not limited to, human sciences (e.g., mathematics), English language arts/literacy and other Areas of Knowledge (“AOK”). Examinee input to one or more computing devices can be in the form of key strokes, audible directions/instructions, physical gestures, or other tactile or non-tactile input methods. Analysis of an input, according to at least one embodiment of the present disclosure executing on one or more computing devices, determines the presence and strength or absence of evidence of justification and explanation skills in accordance with one or more dimensions using one or more example sets, such as those set forth in further detail herein. Dimensions can be iterated across a set of dimensions (e.g., Dimension 1, Dimension 2, . . . Dimension Ni). By applying the one or more dimensions using the one or more example sets, an overall score along with other outputs contemplated herein can be computed. In another embodiment, evidence of justification and explanation skills identified in responses can be annotated and included in one or more reports output from the computing device as pictorially illustrated in FIG. 1B. Analysis of an input, according to at least one embodiment of the present disclosure pictorially illustrated in FIG. 2 and executing on one or more computing devices, can also be configured to determine the presence and strength or absence of evidence of justification and explanation skills in accordance with one or more rubric statements using one or more example sets, such as those set forth in further detail herein. Determining existence of evidence of justification and explanation skills can be iterated across a set of rubric statements (e.g., S1,1, S1,2 . . . Si,j) at varying proficiency/skill level, where Si,j corresponds to statements j at Level i as set forth herein. In at least one exemplary embodiment, the system may be configured to determine presence or absence of evidence of rubric statements Si,j using example sets. Thereby, as discussed above, embodiments of the present disclosure may be configured to determine justification and score by the level (see also FIG. 3) and provide annotations of evidence if it exists. In other embodiments, the overall score(s) can be determined using one or more lookup tables, and desired report(s) can be output. Determining justification statement evidence input, as shown pictorially in FIG. 3 and further set forth herein, includes determining initially if there is at least one positive response statement (i.e., evidence that the student has the skill) present at a chosen Level X. If no positive response statement is present at Level X, a computer executed query determines if there is at least one negative statement present at Level X. If it is determined that there is not one negative statement (i.e., evidence that the student does not have the skill) present at Level X, the output reports no evidence of justification skills at Level X. Alternatively, if it is determined that there is at least one negative statement present at Level X the output reports that there is negative evidence of justification skills at Level X. If in the initial determination it is concluded that there is at least one positive statement present at Level X, a computer executed query determines if there is at least one negative statement present at Level X. If it is determined that there is not one negative statement present at Level X, the output reports there is positive evidence of justification skills at Level X. Alternatively, if it is determined that there is at least one negative statement present at Level X the output reports that there is mixed evidence of justification skills at Level X. Examples of positive and negative evidence at varying proficiency/skill levels is set forth in more detail, for example, herein.

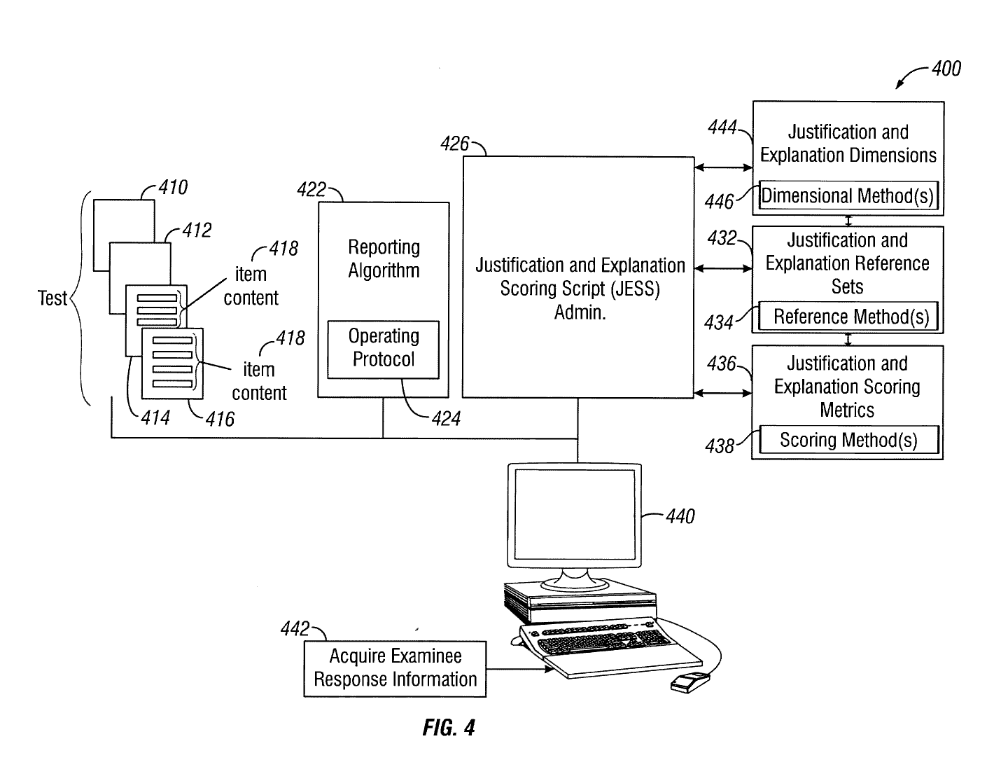

FIG. 4 is a block diagram providing an overview of an illustrative embodiment of the present disclosure for identifying evidence of justification and explanation skills using a computer administrated Justification and Explanation Scoring Script (“JESS”). The system 400 pictorially represented in FIG. 4 is configured to identify evidence of justification and explanation skills in examinee responses by administrating justification and explanation scoring scripts 426 on a computing device 440. According to one embodiment, the system 400 provides for computer administrated and computer automated scoring of one item content 410-416. The item content 410-416 may include adaptive item content and non-adaptive item content. The test item content can be constructed response test items covering a variety of domains, including but not limited to, human sciences (e.g., mathematics), English language arts/literacy and other Areas of Knowledge (“AOK”). Examinee input 442 to one or more computing devices 440 can be in the form of key strokes, audible directions/instructions, physical gestures, or other tactile or non-tactile input methods. Executing on one or more of the computing device 440, the JESS analyzes acquired examinee response information 442. JESS can also be administrated remotely from one or more remote electronic storage/operating locations, accessible with the computing device 440. Executing one or more dimensional methods 446, the computing device 440 in system 400 can be configured to determine the presence and strength or absence of evidence of justification and explanation skills in accordance with one or more dimensions 444 using one or more example sets, such as those set forth in further detail herein. Similarly, executing one or more reference methods 434, the computing device 440 in system 400 can be configured to determine the presence and strength or absence of evidence of justification and explanation skills in accordance with one or more reference sets 432, such as those set forth in further detail herein. Also, by executing one or more scoring methods 438, the computing device 440 in system 400 can be configured to determine the presence and strength or absence of evidence of justification and explanation skills in accordance with one or more scoring metrics 436, such as those set forth in further detail herein. A reporting algorithm 422, executing on the computing device 440, under control of one or more operating protocols 424, can be configured to provide in the form of one or more outputs one or more reports, including features in a response representing evidence of justification and explanation skills and analysis of the evidence in the form of feedback to students, parents, teachers, human scorers/graders, or others. Output from the reporting algorithm 422 executing on one more computing devices can be in the form of annotated representations of the responses, summaries of the response characteristics, scores and other modes.

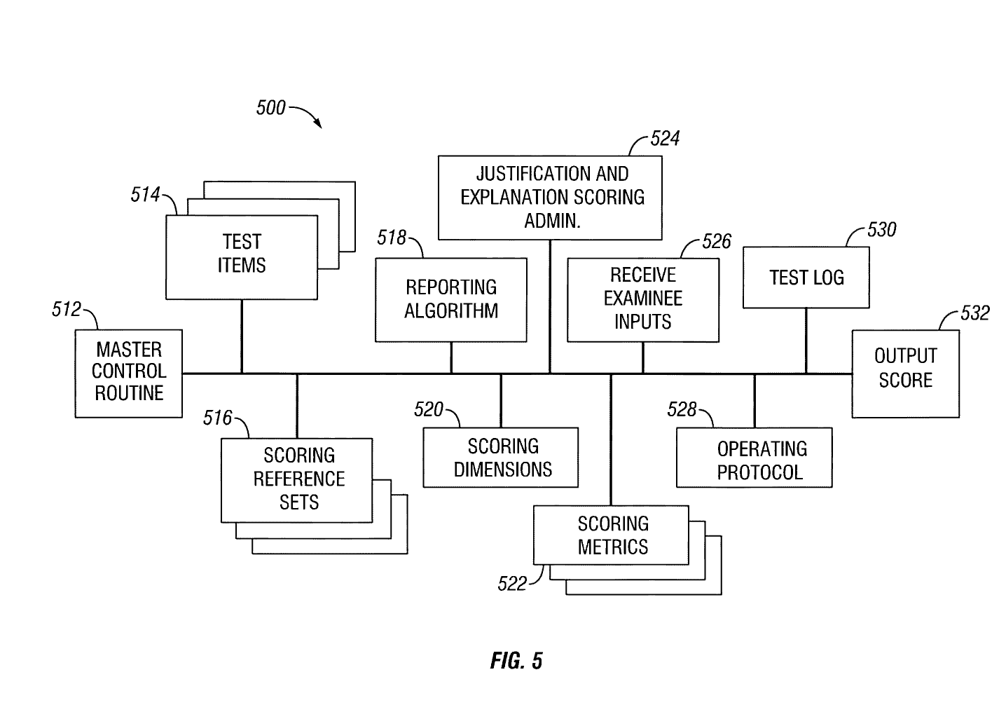

FIG. 5 is a flowchart providing an overview of a system 500 for identifying evidence of justification and explanation skills using a computer administrated Justification and Explanation Scoring Script (“JESS”) 524 and in accordance with an illustrative embodiment. The system 500 pictorially represented in FIG. 5 is configured to identify evidence of justification and explanation skills in examinee responses by administrating justification and explanation scoring scripts 524 on, for example, a computing device 440 shown in FIG. 4. The system 500 includes a master control routine 512 for providing an output such as a score 532 or other forms of output disclosed herein. The master control routine 512 administers test items 514 to an examinee. The test items 514 can be constructed response test items covering a variety of domains, including but not limited to, human sciences, English language arts/literacy and other areas of knowledge. The master control routine 512 can be configured to receive examinee inputs 526 in the form of key strokes, audible directions/instructions, physical gestures, or other tactile or non-tactile input methods. The justification and explanation scoring script 524 is administrated by the master control routine 512 and/or operating protocol 528. The each examinee input 526 two test items 514 under operable control of the master control routine 512 and/or operating protocol 528 examinees examinee inputs 526 41 or more test items 514 to determine presence and strength or absence of evidence of justification/explanation using one or more scoring dimensions 520, one or more scoring reference sets 516, and one or more scoring metrics 522. These operations may occur at varying levels of proficiency and/or skill level of the examinee. The master control routine 512 and/or operating protocol 528 may be configured to create one or more test logs 530 from execution of the justification and explanation scoring script 524, execution of the one or more scoring dimensions 520, execution of the one or more scoring metrics 522, and/or execution of the one or more scoring reference sets 516. Made operable by one or more computing devices, the master control routine 512 in the/or operating protocol 528 of the be configured to access, store, and transmit the via transitory computer readable media, non-transitory computer readable media, and electronic transmission corridors and test items 514, examinee inputs 526, scoring reference sets 516, scoring dimensions 520, scoring metrics 522, and/or other criteria about identifying evidence of justification and explanation skills, criteria and instructions for reporting, one or more generated reports, and programming instructions. Executing the justification and explanation scoring script 524, the master control routine 512 and/or operating protocol 528 may be configured to output one or more scores 532 under operable control of the reporting algorithm 518. Other forms of output 532 under operable control of the reporting algorithm 518 include, for example, feedback to and examinee, parent, teacher, human score, or others in the form of annotated representations of the responses, summaries of response characteristics, scores, and other modes. Still other forms of output 532 can include scores, comments, annotations and/or highlights, tags, or other sorts of data.

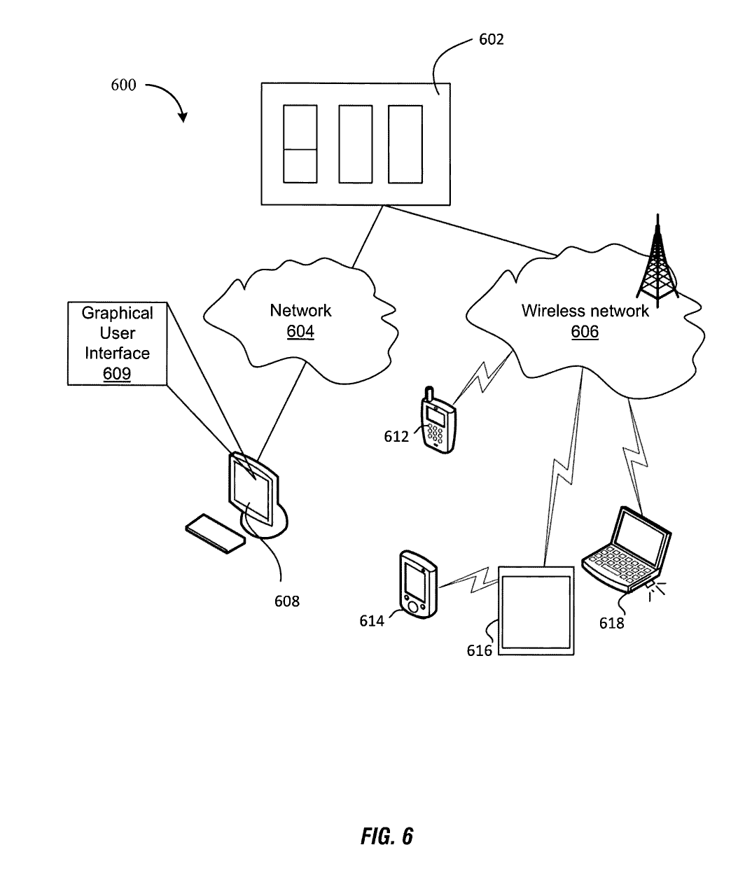

FIG. 6 provides a pictorial representation of a data and/or communications management system 600 for operating methods and systems of the present disclosure. The data and/or communications management system 600 can be configured to use one or more devices, infrastructure, and platforms for enabling, initiating, routing, and managing communication between an electronic or computing device and components of the data/communication system. The system 600 illustrated in FIG. 6 may include one or more devices networked to manage the network or wireless network. For example, the data or communications management system may include any number of servers (i.e., application, database, name, proxy, web, mobile, communications, catalog, etc.), MSCs, NSSs, HLRs, BSSs, UTRANs, VLRs, routers, switches, or advanced intelligent network devices. In one aspect, the data or communications management system, network 604 and wireless network 606 may represent a cloud network system (or managing portions of a cloud network), mesh network, or server farm. The data or communications management system, network, or wireless network may also include web servers or database servers. The servers may communicate data and perform other features associated with the disclosed embodiments, such as for example, accessing one or more test items with the one or more computing devices, administering the one or more test items to an examinee, acquiring a response to the one or more test items from the examinee, accessing a set of criteria for determining presence and strength or absence of evidence of justification and explanation skills, and providing one or more reports. The servers may be configured for applying the set of criteria to the response, identifying one or more types of evidence of justification and explanation skills within the responses to the one or more test items, producing a representation of the one or more types of evidence of justification and explanation skills contained in the response, accessing with the one or more computing devices one or more reporting algorithms for processing the representation of the one or more types of evidence of justification and explanation skills, and applying the one or more reporting algorithms to the representation of the one or more types of evidence and explanation skills. The servers may also be configured for transmitting a report to one or more recipients, detecting and interpreting the response from the examinee on the one or more computing devices from input through a keyboard, mouse, touch-screen, or other input mechanisms, and storing the one or more test items.

In one embodiment, the data/communications management system 600 may generate a portal usable by one or more devices (e.g., laptop 618, tablet 616, smartphone 614, cellphone 612, or computer 608 using graphical user interface (GUI) 609). A portal may be a website that functions as a central point of access to information on the internet or an intranet. The portal may be accessed from any electronic or computing device or communication system or device enabled to communicate through a network connection, either wirelessly or through wired connection. The portal may be utilized to receive information relating to one or more of the functions, processes or operations of the present invention. In one embodiment, the portal may be a web-based mobile application. The web-based mobile application may be useful in areas with extensive network coverage and user utilizing any number of different mobile platforms. The web-based mobile application may utilize the newest versions of language, such as HTML (e.g., five, six, etc.), CSS, JavaScript, or languages with similar purposes and/or similar functions.

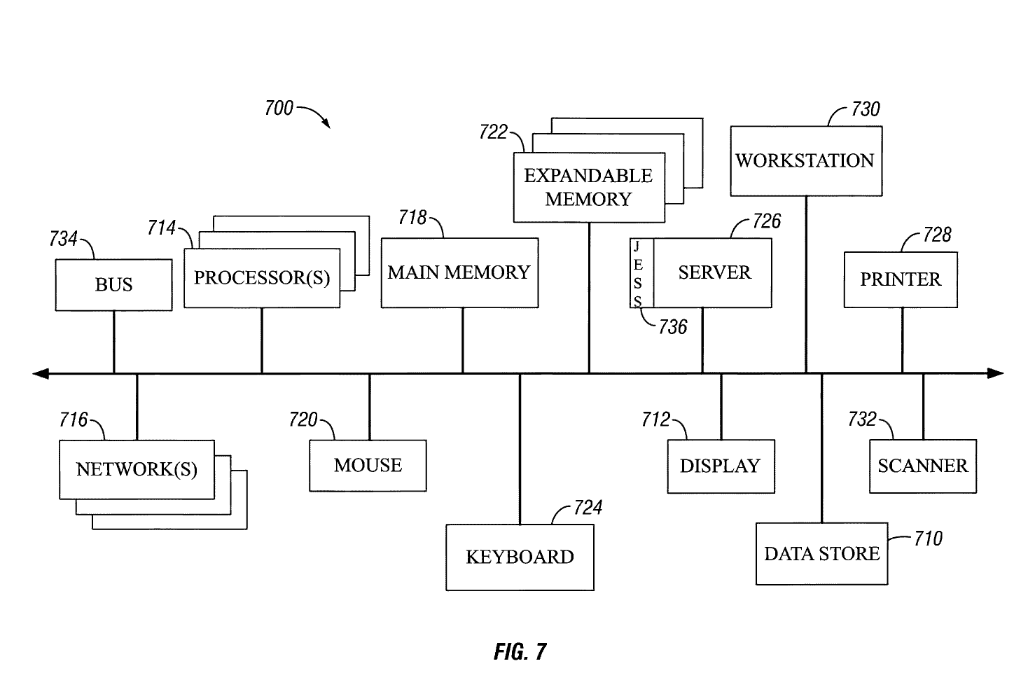

FIG. 7 is a block diagram of a computer network 700 in which embodiments of the disclosure may be implemented. As shown in FIG. 7, the computer network 700 includes, for example, a server 726, workstation 730, scanner 732, a printer 728, a data store 710, and networks 716. The computer networks 716 are configured to provide a communication path for each device of the computer 440 shown in FIG. 4 to communicate with other devices. Additionally, the computer networks 716 may be the internet, a public switchable telephone network, a local area network, private wide area network, wireless network, and any of the like. In various embodiments of the disclosure, a justification and explanation scoring script (JESS) 736, such as the scoring script described in further detail herein, may be executed on the server 726 and/or workstation 730. For example, in one embodiment of the disclosure, the server 726 may be configured to execute the JESS 736, provide outputs of the present disclosure for display to the workstation 730, and receive inputs from the workstation 730. In various other embodiments, the workstation 730 may be configured to execute the JESS 736 individually or co-operatively with one or more other workstations. The scanner 732 may be configured to scan textual content and output the content in a computer readable format. Additionally, the printer 728 may be configured to output the content to a print media, such as paper. Furthermore, data associated with any one or more methods and/or systems of the present disclosure, may be stored on the datastore 710. The datastore 710 may additionally be configured to receive and/or forward some or all of the stored data. Moreover, in yet another embodiment, some or all of the computer network 700 may be subsumed within a single device.

Although FIG. 7 depicts a computer network, it is to be understood that the disclosure is not limited to operation within a computer network, but rather, the disclosure may be practiced in any suitable electronic device. Accordingly, the computer network depicted in FIG. 7 is for illustrative purposes only and thus is not meant to limit the disclosure in any respect.

FIG. 7 also illustrates a block diagram of the computer system 700 in which an embodiment of the disclosure may be implemented. As shown in FIG. 4, the computer system 700 includes a processor 714, a main memory 718, a mouse 720, a keyboard 724, and a bus 734. The bus 734 may be configured to provide a communication path for each element of the computer system 700 to communicate with other elements. The processors 714 may be configured to execute a software embodiment of the JESS 736. In this regard, a copy of computer executable code for the JESS 736 may be loaded in the main memory 718 for execution by the processor(s) 714. In addition to the computer executable code, the main memory may store data associated with any one or more methods and/or systems of the present disclosure. In operation, based on the computer executable code for an embodiment of the JESS 736, the processor(s) 714 may be received by a display adaptor (not shown) and converted into display commands configured to control the display 712. Furthermore, in a well-known manner, the mouse 720 and keyboard 724 may be utilized by a user to interface with the computer system 700, such as computer 440 shown in FIG. 4. The networks 716 may include a network adaptor (not shown) configured to provide two-way communication between the networks 716 and the computer system 700. In this regard, the JESS 736 and/or data associated with the JESS 736 may be stored on the networks 716 and accessed by the computer system 700, such as computer 440 shown in FIG. 4.

Additional aspects of the disclosure include, in part, an online platform/application where the user of one or more parts of the disclosure (e.g., testing agency, teachers, parents, or students) can access responses for an appropriate subgroup (one examinee or a particular group of examinees) as well as the scores and comments that are associated with those responses. The user could then also view progress over time by either viewing responses over time or score summaries and comments over time. They would also be able to select a particular subset of responses and run an aggregate-level analysis on the group of responses (instead of just a single response). This platform or application would allow the user to input a response to a prompt and have it scored automatically.

It should also be appreciated that the aspects of the disclosure can take many forms. For example, while it is included that one or more computing devices be used to identify the justification and explanation of the responses, it should be appreciated that the responses of the examinees can take many forms. These responses can be inputs via one or more computing devices, handwritten responses, oral statements, visual responses, or some combination thereof. For example, computing inputs can take the form of a response on a computing device. Written statements can be written via the computing device or on a separate medium (e.g., writing utensil and paper) and uploaded to a computing device. The handwriting can be determined via a recognition system and then the response included in the handwriting can be examined with the justification and explanation of the present disclosure to determine a score for the response. For oral statements a speaker, microphone, or other oral device can receive a prompt from an examinee and can be recognized via a recognition system and evaluated via the justification and explanation to score the response. For visual responses, a camera, sensor, or other electromagnetic wave sensor can determine a movement of an examinee and then can recognize the movement via a recognition system and then evaluate the movement via the justification and explanation to score the movement. This can include any movement, including, but not limited to, sign language and other movements.

The following includes information, examples, and other disclosure that, while pertinent to the present disclosure, is not to be limiting or otherwise be viewed as anything more than exemplary additions to the disclosure.

### Exemplary Rubric Statement Naming Conventions

### Statement Groups

Some rubric statements belong to a statement family and some do not. Some rubric statements are positive statements and some rubric statements are negative statements. The disclosure uses the convention of statements for positive statements and always refers to negative statements as negative statements.

Statements that Belong to Statement Families

Positive and negative statements that belong to a larger family of statements are identified by a code consisting of three letters followed by a one-digit number. The three letters are supposed to help a reader understand to what family the statement belongs. The number following the letters identifies the statement's level of complexity relative to other statements in the family; that is to say, higher numbered statements capture more complex justification skills. As an example, the statement “Explain why a step in a procedure is necessary” referred to as PRO2. PRO2 tells the reader that the statement belongs to the procedure family, as indicated by “PRO,” and that the statement is more complex than the PRO1 statement. **NOTE** The numbers do NOT indicate any particular justification level, nor do they indicate a progression.

### Stand-Alone Statements

Stand-alone statements are identified by a three-letter code. However, since these statements are not grouped with other similar statements, there is no need for a number at the end of the code. For example, the statement “State a definition, theorem, formula, or axiom” is referred to as DEF since there are no other statements associated with it.

### Negative Statements

Negative statements are identified by a three-letter code that may or may not be followed by a number (depending on whether the statement belongs to a family of negative statements). However, to indicate that the statement is a negative statement, the three-letter code is preceded by an “N.” For example, the negative statement “Uses proof by example” is referred to as N-EXA.

### Justification Statement (PRT): State a Property or Classification of an Object

A property is defined as a characteristic that an object always possesses or never possesses. Classifying is defined as an act of grouping objects based on at least one common characteristic. The dictionary definition of characteristic as defined by Merriam-Webster “belonging to or especially typical or distinctive of the character or essential nature of” will be used.

PRT: State a property of classification of an object.

### Scoring Notes

Given an object, properties are the things about the object that are readily identifiable. Anytime a characteristic can be viewed as a common symbol (<, =, ≅, etc.), we call this a Relationship NOT a property. The word “is” is sometimes treated as an indicator word for properties and sometimes treated as an indicator word for a Relationship. If the two objects on either side of the “is” are measurements, variables, numbers, or any combination of these, then the “is” will be captured by a Relationship. PRT statements are not allowed to occur inside of other statements like Conditionals or DEF. In some cases a property will have a modifier that attempts to add additional information to the central property; this will only be captured as one PRT statement. For example, “the circle has a center” is captured as a single PRT. Likewise, “the circle has a center at (1,2)” is also considered a single PRT. The claim made by the student need not attempt to classify an object, but must only state a classification of that object. A PRT acts as a single Statement in Logical Flow. It is important to note the claim by the student need not be correct. If a property or classification is given in the prompt and then repeated, this statement is not awarded to the repetition.

### EXAMPLES

| | |
|---|---|
| 2 is even | The object is two and the property is evenness. |
| 3 is negative | Note: this is incorrect but is still awarded PRT. |
| Shape ABCD is a | In this case the object is shape ABCD and the |
| square | property is being a square. |
| P(x) = x³ + 2 is of | The object is the function P(x), and the property |
| degree 3 | is of degree 3. |
| 4 is divisible by 2 | While it could be argued there are two objects, |
| | there is only one object that has a property; thus, |
| | 4 is the object and the property is being divisible |
| | by 2. |
| The circle has a center | The object is a circle and the property is having a |
| | center. |
| 3 is in the set of real | 3 is the object and being in the set of real |
| numbers | numbers is a property. |
| Angle A is acute | The object is Angle A and the classification is |
| | being acute. |
| Triangle ABC is not | The object is Angle A and the classification is |
| isosceles | being not isosceles. |

### NON-EXAMPLES

| | |
|---|---|
| 2 is less than 4 | Since “less than” can be viewed as “<”, this is not a |
| | property, and thus, not captured by this statement, but |
| | is instead considered a REL. |
| A triangle has | The article “A” indicates many triangles. This would be |
| three sides | captured by statement DEF. |
| If 4 is divisible | This is not captured by this statement (PRT), since it is |
| by 2, then 4 | conditional and is classified as statement CON1. |
| is even | |
| M ∠ is 180° | This is not captured by this statement (PRT), since in |
| | this case the word “is” is between a measurement and a |
| | number, and thus, is considered a Relationship. |

### Justification Statement (DEF): State a Definition, Theorem, Formula, or Axiom

DEF: State a definition, theorem, formula, or axiom.

### Scoring Notes

The main difference between DEF and “state a property or classification of an object” is the student's ability to speak abstractly—that is, to be general. For example, instead of discussing a single square, discuss many squares. For the most part, any general statement will be captured by DEF. The pronoun “it” can be captured by this statement if it is clear that the antecedent is general. For well-known theorems, the student can state the name of the theorem instead of spelling out said theorem (e.g. by the Pythagorean Theorem). A DEF will act as a single Statement in Logical Flow. It is important to note the claim made by the student need not be correct to award this statement. If a definition, theorem, formula, or axiom is given in the prompt and then repeated, DEF is not awarded to the repetition.

### EXAMPLES

| | |
|---|---|
| A square has four | The article “A” indicates that the student is |
| congruent sides | speaking about all squares. |
| The sum of two evens is | Here the student has stated a mathematical truth |
| even | (axiom); thus, the student has demonstrated this |
| | statement (DEF). |
| $Slope is \frac{{y}_{2} - {y}_{1}}{{x}_{2} - {x}_{1}}$ | The student has provided the general slope formula. |
| If two corresponding | The student has provided a general theorem. |
| angles of two triangles are | Note: the statement is also conditional, which is |
| congruent, then any two | acceptable for this statement. The word “any” |
| triangles are similar. | also indicates many; therefore, this DEF is |
| | present. |
| Squares have four sides | This is considered “general.” Square is plural, |
| | indicating many squares. |
| All cubic functions have at | The word “All” indicates many cubic functions; |
| least one real solution | thus, the claim is captured by this statement |
| | (DEF). |
| The definition of an acute | While this statement is incorrect, the student has |
| angle is an angle with a | made it clear they are speaking generally “The |
| degree measure greater | definition of an acute angle is . . . ” and thus, the |
| than 90° | response is captured by this statement (DEF). |

### NON-EXAMPLES

| | |
|---|---|
| This square has | The word “This” indicates a single square, so the |
| four sides | student has not demonstrated this skill, but rather |
| | is captured by PRT. |
| That function | The word “That” indicates a single function; thus, |
| is positive | it is not captured by this statement, but rather by |
| | PRT. |

### Justification Statement (REL): State a Relationship Between Two or More Objects

A relationship is defined as a comparison/contrast of characteristics between two or more objects.

REL: State a relationship between two or more objects.

### Scoring Notes

A comparison/contrast will be elicited by certain comparison words (e.g. greater than, smaller, above, etc.). Similar to theorems, there are certain phrases that indicate a relationship; they will also be captured by this statement (e.g. parallel, congruent, corresponding, inverse, etc.). The word “equal” will always indicate REL. However, this does not always apply to the word “is.” If the two objects on either side of the “is” are measurements, variables, numbers, or any combination of these, then this statement will apply. There is also the case of “comparison conjunctions” (both, while, also, however, etc.). In the event that there is a “comparison conjunction,” REL will apply. The conjunctions “but” and “and” by themselves would not be captured by REL—but “comparison conjunctions” along with “but” and “and” do allow REL to apply. REL's should not occur inside other statements. However, a REL could span or encompass two or more distinct statements; this often occurs when a comparison conjunction is present. When a REL spans two or more statements due to comparison conjunction, the REL will not appear in Logical Flow. It is important to note the claim made by the student need not be correct. If a relationship is given in the prompt and then repeated, REL is not awarded to the repetition.

### EXAMPLES

| | |
|---|---|
| Side A is longer | The two objects are Sides A and B. The |
| than Side B | comparison is indicated by “longer than.” |
| Angle A is congruent | The two objects are Angle A and Angle B and the |
| to Angle B | relationship is indicated by “congruent to.” |
| 4 > 2 | The two objects are 4 and 2 and the comparison is |
| | indicated by the greater than symbol. |
| 3 + 5 = 6 | While this is incorrect, the examinee has related |
| | the left hand side to the right hand side through |
| | the “=.” |
| f(x) is below g(x) | The two objects are f(x) and g(x). The |
| | comparison is indicated by “below.” |
| Side A is short while | This does indicate a relationship, because the |
| Side B is long | word “while” shows a distinction between the |
| | two sides. Moreover, both “Side A is short” and |
| | “Side B is long” are separate Statements that |
| | should be captured as PRT's. |
| A and B are both | There are two objects “A and B” present and the |
| negative numbers | word “both” indicates the objects share a property |
| | (being negative); thus, this is a relationship and is |
| | captured by REL. |
| m <1 is 180° | This is captured by REL since the word “is” is |
| | between a measurement and a number, and thus, |
| | is considered a relationship. |

### NON-EXAMPLES

| | |
|---|---|
| Side A is short and | The examinee has two properties, but has not |
| Side B is long | compared or contrasted them. Also, in this case |
| | there are two properties that would be captured |
| | by statement PRT. |
| 2 is both even and | While there is the word “both”, there is only one |
| positive | object discussed; thus, this is not a relationship. |
| | It is only captured by statement PRT. |
| All squares have four | Note that the entire statement would be |
| congruent sides | considered a DEF. As such, while there is the |
| | word “congruent” appears, “four congruent sides” |
| | is not captured as a REL since that would result |
| | in REL embedded within a DEF. |

### Justification Statement Family (PRO): Procedure Statements

A procedure is a mathematical series of steps used to arrive at a final result.

PRO1: State one or more steps in a procedure.

PRO2: Explain why a step in a procedure is necessary.

### Scoring Notes

PRO1 is captured when students are providing at least one step in a process; in most cases PRO1's will be used to capture “someone verb-ing” (e.g., “I did this,” or “You do that”). If the result of a procedure immediately follows the procedure step, the result is included in the PRO1. For example, “You split it in half to get four pieces” is captured as a single PRO1. Non-steps or things that cannot occur are not captured by PRO1. For example, “You can't divide by 0” is not captured by PRO1. Stating a method will be captured by PRO1 (e.g. use synthetic division). Simply providing a computation will not be captured by PRO1. However, restating a computation in one's prose could be captured in certain cases. The procedure stated by the student can be hypothetical. PRO2 will be applied when an examinee states why a step could be done (e.g. addition is commutative) or why the step needs to be done (e.g. to isolate the x term). “Why the step needs to be done” is the purpose behind the step (e.g. to get x by itself) the “itself” shows purpose. PRO2 will NOT capture the result of a step (e.g. I added 4 and 1 to get 5) this is simply stating a result, so PRO2 will NOT be present. PRO2 and PRO1 are often a progression, so if a response receives PRO2 it can also receive PRO1, but this is not necessarily the case. PRO statements should not occur inside other statements. In Logical Flow, each step in a procedure is considered a separate Statement. Correctness is not considered when awarding these statements. If a procedure is given in the prompt, a repeat of said procedure will not be captured by these statements.

### EXAMPLES

Prompt: Describe a process for converting a measurement from meters to centimeters and explain why that process works.

| | |
|---|---|
| Response 1: | Here the student has stated a procedure |
| If you convert meters to centimeters you ×100. | “you ×100” this demonstrates PRO1 but |
| | NOT PRO2 because there is no additional |
| | reason explaining why you multiply by |
| | 100. |
| Response 2: | The word “could” demonstrates that the |
| First you could move the decimal over. | procedure is hypothetical. However, the |
| | response is still captured by statement |
| | PRO1, but NOT PRO2. |
| Response 3: | Even though the procedure stated is |
| Move the decimal to the left two times. | incorrect, the student has still demonstrated |
| | PRO1 since they have provided at least |
| | one step (move the decimal . . . times). |
| Response 4: | The examinee has stated a step (times your |
| Times your number in meters by 100 because | number by 100) and then provided a |
| centimeters are smaller than meters. | reason that explain why that step can be |
| | done (centimeters are smaller than meters). |
| | So statement PRO1 and PRO2 are |
| | present. |
| Response 5: | The examinee has stated a step (move the |
| There are two more digits in 100 than 1, | decimal to the right two times) and also |
| so move the decimal to the right two times. | provided a reason that explains why the |
| | step should be done (there are two more |
| | digits in 100 than 1). Even though the |
| | reason is specific, PRO1 and PRO2 are |
| | present. |

### Justification Statement Family (ERR): Error Statements

To indicate an error means that the examinee is directing attention to a problem in the body of work or results.

ERR1: Indicate an error occurred.

ERR2: Indicate an error and use a mathematical concept (definition, theorem, or axiom) to explain why an error occurred.

### Scoring Notes

An examinee can be awarded ERR1 for either stating what is thought to be wrong in the work/results or by providing an alternate process/result. Whether the examinee is correct does not matter when applying this statement. However, only repeating prompt information will not be credited with this statement. ERR2 is awarded to responses that use a mathematical concept (true or not) to explain why the error exists. The error statements form a progression, so when ERR2 is awarded, ERR1 should be awarded as well.

### Justification Statement Family (PAT): Pattern Statements

Pattern: A rule for a predictable sequence of numbers, letters, shapes, etc.

PAT1: Explain a pattern using words, algebraic expressions, numeric operations OR generate a sequence from a rule.

PAT2: Use a pattern or sequence to support a Statement or Conclusion.

PAT3: Introduce a pattern or sequence and use it to support a Statement or Conclusion.

### Scoring Notes

The purpose of PAT1 is to capture when a student explains a pattern in words (e.g., it goes up by 3 each time), with a numeric expression (e.g., +3, +3, +3, . . . ), with an algebraic expression (e.g., a n=2n+1), or when a student generates a sequence from a given rule (e.g., 3, 6, 9, . . . ). Basically, PAT1 captures when a student changes a pattern's form. Simply extending a sequence that was given in the prompt (e.g., 1, 2, 4, 8 was given and the student writes “16”) is NOT captured by PAT1. To be awarded PAT2, a student must use information about a pattern as either a claim that is used to work towards a conclusion or as support for a statement. This pattern information could be lots of things, including the rule for the pattern, the sequence created by the pattern, or perhaps some property of the pattern (e.g. the pattern has to repeat 30 times to get to the 180th digit). However, it is important to note that this pattern information cannot be a direct repetition of information given in the prompt—it must be something new. PAT3 is very much like PAT2 except that to award PAT3, there must be no pattern given in the prompt. In other words, the student has to introduce their own pattern where none was obvious before. Although PAT1 will usually be present when PAT2 or PAT3 are, this is not necessarily the case. However, PAT3 and PAT2 do form a progression, so if PAT3 is awarded, PAT2 must be awarded as well. Correctness is not considered when awarding justification statements.

### EXAMPLE

Prompt: Is zero an even or odd number? Justify your answer.

Response: Zero is an even number because it ends in a zero and that is even. One and negative one are odd and zero is right in the middle. The number pattern is even, odd, even, odd so it would only make sense that zero between two odd numbers would be even.

Explanation: This student explains the rule for a pattern (even, odd, even, odd) and so PAT1 is awarded. Since the student also uses this pattern information as part of the argument, PAT2 is awarded. Finally, as this pattern was not expressly presented in the prompt, PAT3 is awarded.

### Justification Statement Family (CON): Conditional Statements

A conditional statement contains two clauses, the condition (hypothesis) and the consequence(s) (conclusion). The condition is expressed as hypothetical, often introduced by the word if and the consequence is often introduced by the word then.

CON1: Make a conditional statement (e.g. If-Then, When-Then, etc.)

CON2: Conclude from a conditional statement.

CON3: Conclude from a conditional statement and verify that the statement's hypotheses hold.

### Scoring Notes

Consider the statement: School will be canceled if it snows. The condition is the “if it snows” and the consequence is “school will be cancelled” so in this case the “then” was not used, and the two clauses are in a different order. Conditional statements vs. non-conditional statements: Conditional statements describe events that happen hypothetically or conditionally. Ex: “If . . . , then . . . ,” “When . . . , then . . . ,” “Whenever . . . ,” “In order to . . . ,” or “Anytime . . . ” (conditional statements) Conditional statements do NOT occur when statements are describing something that has already happened, already exists, or was stated to be true. Those types of statements are captured by other justification statements. Ex: “Since . . . , then . . . ” (NOT a conditional statement).

Conditional statements follow these forms, but do not have to be mathematically true:

| CON1 | CON2 | CON3 |
|---|---|---|
| A → B | A → B | A → B |
| | ∴B | A |
| | | ∴B |

As illustrated in the previous bullet, CON1, CON2, and CON3 form a progression. So, if you award CON3, CON2 and CON1 should be awarded as well. If you award CON2, then CON1 should be awarded with it. Conditional statements should not include other statements except for Computations and Examples. If a Computation is stated conditionally, it is counted as a computation and not as a conditional statement. A conditional statement acts as a single Statement in Logical Flow. Correctness is not considered when awarding these statements. Conditional statements that are given in the prompt and restated again in the response will not be awarded CON1, CON2, or CON3.

### Justification Statement Family (VIS): Visual Representation

A visual representation is a visual that represents data, objects or mathematical concepts. (Examples: Tables, graphs, geometric shapes, Venn diagrams, function mappings, pie charts, histograms, etc.) Prose is a body of writing. Prose does not include the conclusion of an argument.

VIS1: Provide a visual representation.

VIS2: Draw and label a visual representation that illustrates a mathematical concept, property, or relationship.

VIS3: Draw and label a visual representation that illustrates a mathematical concept, property, or relationship and use the labeling in one's prose to clarift an argument.

### Scoring Notes

Labels do not have to be present for VIS1. Labels can be in the form of assigning points (A, B, & C), just writing numerical values on a diagram, or marking parts congruent. When prompts include pictures, new information or new labels must be added to the given picture in order to get credit for visual representation justification. VIS1, VIS2, and VIS3 form a progression. So, if you award VIS3, VIS2 and VIS1 should be awarded as well. If you award VIS2, then VIS1 should be awarded with it. Correctness is not considered when awarding justification statements; however, VIS3 must be internally consistent. If a diagram and the prose show contradictory ideas then the argument is not internally consistent and no VIS3 is awarded. (See the examples on the following pages.) Special Case VIS3: To get VIS3, a labeled Visual Representation must be present and students must reference the labels. However, sometimes students draw an arrow to the labeled diagram instead of using their labels in the prose. This is acceptable.

### Justification Statement Family (CMP): Computations

A computation is an algebraic or numeric calculation/manipulation or the documentation of an algorithm. For example, multiplication, subtraction, factoring, simplification, long division, and synthetic division are all considered computations.

CMP1: Provide a computation.

CMP2: Use a computation to Support a Statement or Conclusion.

### Scoring Notes

CMP1 simply means that the examinee performs a computation in the response—nothing more is needed. Substitution alone is not a CMP1. However, if the examinee substitutes and then does a calculation or simplifies using the substituted value, then a CMP1 is present. CMP1s can be stated verbally e.g., Two plus two is four. CMP2 means that the examinee performs a computation and then uses the computation as either a Claim or as Support for a Statement; this means that Logical Flow must be present in order to award CMP2. Computations can be REL's when the computation includes comparison symbols or words. If a student states a calculation conditionally, it will be awarded Computation and not a Conditional Statement. Computations are allowed to occur inside of Conditional Statements. In Logical Flow, computations that occur in the body of an argument can be counted as Statements. An entire computation is considered a single Statement in this case. Furthermore, related computations occurring back-to-back are only counted as a single statement (e.g., 2+2=4/2=2). The only exception to this rule is computations that are also counted as steps in a Procedure; in this case, each step is considered a single statement as per the procedure rules. If the computations are separate but occur sequentially in the response, they may be considered separated statements (e.g. 2+2=4 180/6=30). Finally, if a computation is outside of the body of an argument, the computation will be counted as a Claim, assuming that a Conclusion is present. Statements CMP1 and CMP2 form a progression. Hence, if you award CMP2, then CMP1 should be awarded as well. Computations that are given in the prompt and restated again in the response should not be awarded CMPs. Correctness is NOT considered when awarding justification statements. Incorrect calculations are still credited with CMP justification.

### Justification Statement (EXA): Provide Example

Example: A specific member or instance of a general class, rule, or situation.

EXA: Provide an example.

### Scoring Notes:

An example occurs when a student creates a specific instance of something that was previously mentioned (by prompt or by student). Assigning values to variables counts as an example. A student does not have to provide a correct example to be awarded this statement. Examples can be stated conditionally and are, in fact, allowed to occur inside of conditional statements. In Logical Flow, an example that occurs in the body of an argument can be counted as a Statement. The entire example is considered a single Statement. Any results following the example are considered separate Statements.

### EXAMPLES

Prompt: Mikayla thinks the expression n²+n−1 will always produce prime numbers when n is an integer greater than 1. Is Mikayla correct? Explain why or why not.

Response: Mikayla is not correct. If I use n=7, I get 55, but 55 is not prime.

The student is awarded EXA since a specific value (7) was assigned to a variable (n).

Prompt: Explain how you know when a triangle is a right triangle.

Response: A triangle is a right triangle when the sum of the squares of two sides is equal to the square of the third side, like in a 3, 4, 5 triangle.

The student gives an example of a specific triangle (a 3, 4, 5 triangle) that demonstrates the previously discussed rule and so EXA is awarded.

### Justification Statement Family (CNE): Counterexamples

An example that refutes or disproves a proposition.

CNE1: Provide a counterexample of a conditional statement.

CNE2: Provide a counterexample and verify that the conditional conclusion does not hold for the example.

CNE3: Provide a counterexample and verify that the conditional hypotheses do hold for the example, while the conditional conclusion does not.

### Scoring Notes

Since a counterexample is first and foremost an example, any response that is awarded CNE1, CNE2, or CNE3 should also be awarded EXA (Provide an example). CNE1, CNE2, and CNE3 require that the student conclude that the proposition is false in addition to providing the counterexample. There are a few special cases where this rule does not apply (like when the prompt simply says, “Disprove.” A counterexample need not be true in order to award these statements. CNE2 occurs when the student tells you where to look for a counterexample and then also explicitly shows that the counterexample disproves the proposition. CNE3 occurs when a student tells you where to look for a counterexample, demonstrates that the proposed counterexample meets all of conditional statement's hypotheses, and, finally, shows explicitly that the conditional statement's conclusion does not hold for the counterexample.

### Summary of Statements CNE1, CNE1, and CNE3

The best way to form an understanding of how to apply these counterexample statements is to analyze the conditional statement that the counterexample will disprove. Identifying what the hypotheses and conclusion of the claim are will help you understand when each statement will apply.

Prompt: Mikayla thinks the expression n²+n−1 will always produce prime numbers when n is an integer greater than 1. Is Mikayla correct? Explain why or why not.

Any claim that can be disproven by a counterexample will have conditions that have to be met by the counterexample and a conclusion that must be shown to be false by the counterexample. If we analyze the above prompt we see that Mikayla thinks that n²+n−1 will produce prime numbers when n is an integer greater than 1. We can rearrange this into a conditional statement: If n is an integer greater than 1, then n²+n−1 will produce a prime number. By doing this we see that the condition required by the claim is that an integer greater than 1 is used. The conclusion is that taking n²+n−1 will then produce a prime number. So, in order to get CNE3 for this prompt, a student would have to provide a counterexample, state that the counterexample comes from an integer greater than 1, and finally note that the number that results from n²+n−1 is not prime. This may seem extremely stringent, but understanding what conditions your counterexample must meet and what it takes to disprove a conclusion are very important aspects of understanding counterexamples.

### Justification Statement Family (LFD): Logical Flow

Statement: A mathematical sentence presented as true by the examinee; the basic unit of justification.

Specific Statement: A mathematical sentence involving only concrete or named objects, figures, equations, etc. (e.g. 2, the shape, that number, Square ABCD) that describes attributes, relationships, or interactions.

General Statement: A mathematical sentence that describes definitions, theorems, formulae, axioms, math rules, or describes attributes, relationships, or interactions between classes of objects (e.g., all squares have four congruent sides, a quadrilateral has four sides, the sum of two even numbers is even, the Angle-Angle Similarity Postulate states that two triangles are similar if and only if they have two angles that have equal measures, the area of a square is l*w).

Conclusion: The end of an argument; a statement that explicitly follows from others.

Claim: A statement that is used to conclude; the building block of an argument.

Support: A statement that is explicitly used to explain why a claim can be made. When a Specific Statement is used as Support, the Support is said to be Specific Support.

When a General Statement is used as Support, the Support is said to be General Support.

LFD1: Use a Specific Statement to draw a Conclusion or Provide Specific Support for a Statement.

LFD2: Use two or more Specific Statements to draw a Conclusion.

LFD3: Use a General Statement to draw a Conclusion or Provide General Support for a Statement.

LFD4: Use a Claim to draw a Conclusion and provide Specific Support for the Claim.

LFD5: Use a Claim to draw a Conclusion and provide General Support for the Claim.

LFD6: Use a Specific Statement and a General Statement to draw a Conclusion.

LFD7: Use two or more Specific Statements to draw a Conclusion and provide Specific Support for at least one of the Claims.

LFD8: Use two or more General Statements to draw a Conclusion.

LFD9: Use two or more Claims to draw a Conclusion and provide Support for at least one Claim—at least one Claim or Support must be General.

### Scoring Notes

The important things to keep in mind when scoring Logical flow are: Does the response have an explicit Conclusion? How many Claims are there? Do any of the Claims have Support? Are the Claims and Support General or Specific?

When trying to decide between General and Specific, try and determine whether the student is talking about concrete, specific objects and their properties, or if they student is talking about classes of objects or the general rules of math. If the student is talking about a named object (e.g. Triangle ABC or the function f(x)), then the student is most likely being specific. To have an explicit Conclusion, a student must use identifier words such as “so” and “therefore.” Without these identifier words, there cannot be a Conclusion. However, there are some specific prompts that are allowed to have “implied” conclusions—these will be determined on a prompt-by-prompt basis and usually occur when the prompt says, “Explain why . . . ” or “Prove.” Sometimes “so” is used to indicate sequence and sometimes it is used to indicate Conclusions—if it is not clear, “so” is considered a concluding word. Phrases like “which makes” and “this means” are considered identifier phrases for Conclusions.

To have support, a student must use identifier words such as “because” and “since.” Without these identifier words, there cannot be support. When counting the number of Statements, if context allows, any sentence containing a conjunction like “and” should be split into multiple Statements. For example, the sentence “the square has four congruent sides and four right angles” should be split up to count as “the square has four congruent sides” and “the square has four right angles.” So, even though it is a single English sentence, it should be broken apart to count as two Statements. The conjunction “or” often does not split, except occasionally in the case of a compound sentence formed by an “or.” If something is acting as support for a Statement contain the conjunction “and,” the support is distributed to both statements resulting from splitting the “and.” A period, like in English, ends a mathematical sentence. If context allows, sentences formed by multiple clauses should be split apart into separate Statements. Each step in a Procedure is considered a separate Statement. Computations that occur in the body of an argument can be counted as Statements. An entire computation is considered a single Statement in this case. Furthermore, related computations occurring back-to-back are only counted as a single statement (e.g., 2+2=4/2=2). The only exception to this rule is computations that are also counted as steps in a Procedure; in this case, each step is considered a single statement as per the procedure rules. If the computations are separate but occur sequentially in the response, they may be considered separated statements (e.g. 2+2=4 180/6=30). Finally, if a computation is outside of the body of an argument, the computation will be counted as a Claim, assuming that a Conclusion is present. A Conditional Statement is counted as a single Statement in Logical Flow. An Example that occurs in the body of an argument can be counted as a Statement. The entire example is considered a single Statement. Note, however, that a complex example could have its own, separate Logical Flow contain within the example. If the prompt asks a student to “Prove” something, then a Conclusion, either explicit or implicit, is required. In a two-column proof, each line in the left column is considered a Claim or Conclusion and each line in the right column is considered Support (this includes stating “Given”). Logical flow statements form a progression. When awarding a statement, it is important to note any lower level statements that the examinee is inevitably demonstrating. Information given in the prompt is allowed to count as Claims, Support, and Conclusion. Moreover, if given information is used as a Claim or Support then, for Logical Flow purposes, the Statement created by the given is considered Specific if the given is Specific and General if the given is General. If only given information is present, no Logical Flow is awarded.

Logical Flow is concerned with mapping out a student's argument. However, the precision required by Logical Flow is often at odds with the vagaries of language. To mitigate this issue, the above scoring notes provide guidelines that can be used to convert a written argument into a Logical Flow diagram. These guidelines, though, should always be tempered by keeping the context of the student's response in mind.

Here is an example: assume that the prompt at hand is referring to parallel lines and student's response includes, “the lines can be positioned where they do not intersect.” According to the above guidelines, we would split the student's response into two different statements. However, doing this would give us the statements “the lines can be positioned” and “they do not intersect” since those are the two clauses that make up the student's sentence, but it seems clear that the student does not intend “the lines can be positioned” as an independent mathematical thought. In this case, we would keep the student's sentence together as one Statement.

There are lots of situations where the context and guidelines disagree. If not clearly superior determination presents itself, you should default to applying the guidelines.

### Justification Statement Family (CLA): Classification Statements

A class is a group with the same characteristics.

CLA1: State that an object belongs (or does not belong) to a class, state at least one of the common characteristics of the class, and state that the object has (or does not have) those characteristics.

CLA2: State what is required to be a member of a class, verify that an object meets all of those requirements, and then state that the object belongs to that class.

### Scoring Notes

There is a very subtle difference between the two classification statements. For CLA1, a student will mostly likely state a few properties that an object possesses—this is different than expressing exactly what is required to be a member of a class. For example, “All squares have four sides,” but that does not mean that if you have four sides you are automatically a square. For CLA2, a student needs to be very clear about what characteristics are required for an object to be a member of a particular class.

For CLA1 and CLA2, it does not matter in what order the student makes the statements. CLA1 and CLA2 are disjoint. If CLA1 is present then CLA2 is NOT present. If CLA2 is present then CLA1 is NOT present.

### Justification Statement Family (N-EXA): Negative Statements

Most of the Justification Rubric statements capture positive justification skills that the student is demonstrating. However, there are times that students present evidence of justification misconceptions. These misconceptions are captured by statements that are referred to as “negative statements.”

If you award a negative statement and it is the only statement awarded for a given level, that Justification Level should be scored a 1 (Evidence Against that Level). If there are other statements awarded at the same level as the negative statement, then the Justification Level should be scored a 2 (Mixed Evidence for that Level).

N-EXA: Uses proof by example.

### Scoring Notes

There is often a very fine line between proof by example and illustrating with an Example; the latter is not necessarily bad justification. To help ensure that students are not awarded a negative statement for illustrating with an example, Statement N-EXA is only awarded to responses that demonstrate beyond a shadow of a doubt that the student believes that a general result is true because of some number of examples.

N-CNV: States that the converse or inverse of a conditional statement is true because the original statement is true.

### Scoring Notes

Using logic notation, if A→B is a conditional statement, then the converse of the statement is B→A and the inverse of the statement is ˜A→˜B (Not A implies Not B). The contrapositive of a given conditional statement ˜B→˜A (Not B implies Not A) is logically equivalent to the conditional statement. Like Statement N-EXA, this statement has a very strict application. A student must provide evidence beyond a shadow of a doubt that he/she believes that the converse or inverse of a statement is true only because the conditional is true.

### EXAMPLE

Prompt: Prove that all squares are similar.

Response: Since all squares are considered rectangles, I know that all rectangles also have to be squares. I know that all rectangles are similar, so I know that all squares are similar, too.

In this case, the conditional statement is A→B where A is a shape being a square and B is a shape being a rectangle. Statement N-CNV is awarded to this response because the response provides explicit evidence that the student believes the converse of a conditional statement is true only because the conditional statement is known to be true.

### Justification Statement (CAS): Use Cases in a Proof

CAS: Use cases in a proof.

Scoring Notes Cases occur in a proof when a student creates two or more groups and proves a result for each group individually. At least one of the groups must have more than one member. The student's cases do not have to be exhaustive. In other words, if a student mistakenly leaves out a case, this statement can still be awarded. Correctness does not matter when awarding this statement.

### EXAMPLES

Prompt: Is |x|≧x true for all real numbers x? Justify your answer.

Response 1: |x|≧x is true for all real numbers. If x is negative then |x| will be positive which is greater than a negative. If x is positive, then |x|=x which still makes the statement true.

Here the student creates two groups—negative numbers and positive numbers—and deals with each group separately and so CAS is awarded. It should be noted that the student did not consider the case where x=0. This does not prevent CAS from being awarded.

Response 2: If x is positive or 0, the absolute value of x is the same as x and so the statement is true.

This response is NOT awarded CAS. In this case there is only one group (positives or 0) since the “or” is not split apart as per the Conjunction Rules. CAS requires at least two groups to be present.

### Justification Statement (IND): Indirect Proof

IND: Use indirect proof.

### Types of Indirect Proof

There are multiple types of indirect proof. For most of our purposes, an indirect proof is any proof that proves a result to be true by some method other than assuming the given information and applying definitions and theorems. The following are the two most common types of indirect proof.

Proof by Contradiction: This occurs when a student assumes the hypotheses and the negation of the proposition that is to be proven are true. Working from these assumptions, the student then arrives at a contradiction, which implies that the negation of the proposition is false (which means that the original proposition is true).

Proof by Contrapositive: This occurs when the student assume the negation of the desired conclusion and proves the negation of the hypotheses. If we use the common symbolic logic symbols P→Q to represent the conditional we wish to prove, proof by contrapositive looks like: ˜Q→˜P (the negation of Q implies the negation of P) Scoring Notes

To be awarded IND, a student must make it clear that they are assuming something other than the given proposition or hypotheses. A student must either arrive at something that they believe is a contradiction or believe they have proven the negation of the conditional hypotheses to be awarded IND. A counterexample is not considered an indirect proof. Correctness does not matter when awarding this statement.

### EXAMPLES

Prompt: Prove that there is no smallest rational number greater than 0.

Response: Assume that there is a smallest rational number greater than 0. Call it r. Then

$$\frac{r}{2}$$

is a rantional number greater than 0, but

$$\frac{r}{2} < r ,$$

which is a contradiction. Therefore my assumption is false and so there is no smallest rational number greater than 0.

This response is awarded IND since the student assumes the negation of the proposition (Assume that there is a smallest rational number greater than 0) and arrives at a contradiction, which is a proof by contradiction.

Prompt: Prove the following: if x² is even, then x is even.

Response: Assume that x is not even. Therefore, x is odd. An odd times an odd is odd. Therefore, x² is odd, which is not even.

This response is awarded IND since the student assumes the negation of the conditional's conclusion (Assume that x is not even) and then proves the negation of the conditional's hypothesis (Therefore, x² . . . is not even), which is a proof by contrapositive.

The present disclosure is not to be limited to the particular embodiments described herein. In particular, the present disclosure contemplates numerous variations in the type of ways in which embodiments of the disclosure may be applied to computer automated scoring and adaptive testing. The foregoing description has been presented for purposes of illustration and description. It is not intended to be an exhaustive list or limit any of the disclosure to the precise forms disclosed. It is contemplated that other alternatives or exemplary aspects that are considered are included in the disclosure. The description is merely examples of embodiments, processes or methods of the disclosure. It is understood that any other modifications, substitutions, and/or additions may be made, which are within the intended spirit and scope of the disclosure. For the foregoing, it can be seen that the disclosure accomplishes at least all of the intended objectives. The previous detailed description is of a small number of embodiments for implementing the invention and is not intended to be limiting in scope. The following claims set forth a number of the embodiments of the disclosure disclosed with greater particularity.

What is claimed is:

1. A method executing on one or more computing devices for obtaining one or more responses from one or more examinees for identifying one or more features of those responses that represent evidence of justification and explanation skills, the method comprising:
providing one or more computing devices having read and write access to a non-transitory computer readable medium;
accessing one or more test items with the one or more computing devices;
administering the one or more test items to an examinee;
acquiring a response to the one or more test items from the examinee;
accessing a set of criteria with the one or more computing devices;
applying the set of criteria to the response with the one or more computing devices;
identifying, via the one or more computing devices, one or more types of evidence of justification and explanation skills within the responses to the one or more test items;
producing a representation of the one or more types of evidence of justification and explanation skills contained in the response;
accessing with the one or more computing devices one or more reporting algorithms for processing the representation of the one or more types of evidence of justification and explanation skills;
applying the one or more reporting algorithms to the representation of the one or more types of evidence and explanation skills; and
transmitting a report to one or more recipients.

2. The method of claim 1 further comprising:
detecting and interpreting the response from the examinee on the one or more computing devices from input through a keyboard, mouse, touch-screen, or other input mechanisms.

3. The method of claim 1, wherein the set of criteria is determined, at least in part, through analysis by the one or more computing devices of one or more reference sets of responses.

4. The method of claim 1 further comprising:
storing the one or more test items on the one or more computing devices.

5. The method of claim 1, wherein the report includes one or more annotations of the response comprising a specific type of the one or more types of evidence of justification and explanation skills.

6. The method of claim 5 further comprising:
identifying with the set of criteria the specific type of the one or more types of evidence of justification and explanation skills.

7. The method of claim 1, wherein the set of criteria includes at least one criteria for identifying if one or more objects in the representation of the one or more types of evidence of justification and explanation skills are properly identified.

8. The method of claim 1, wherein the set of criteria includes at least one criteria for identifying if relationships between two or more objects in the representation of the one or more types of evidence of justification and explanation skills are properly identified.

9. The method of claim 1, wherein the one or more test items comprise constructed response test items.

10. A method executing on a computing device for identifying features in an examinee response representing evidence of justification and explanation skills, the method comprising:
providing a computing device having a non-transitory computer readable medium;
storing analytical criteria on the non-transitory computer readable medium, the analytical criteria comprises:
a. one or more dimensions for measuring an examinee's justification and explanation skills;
b. one or more reference sets for a response characteristic associated with the examinee's justification and explanation skills; and
c. one or more scoring metrics associated with the one or more dimensions for rating the examinee's justification and explanation skills;
administering to the examinee on the computing device one or more test items;
receiving at the computing device the examinee response to the one or more test items;
applying the analytical criteria stored on the non-transitory computer readable medium to the examinee response to the one or more test items;
the applying step further comprising comparing on the computing device the examinee response to the one or more test items with the one or more reference sets;
outputting from the computing device the one or more scoring metrics for the examinee response to the one or more test items, wherein the output includes a listing from the examinee response evidencing the examinee's justification and explanation skills.

11. The method of claim 10, further comprising:
annotating the examinee response with the one or more reference sets for evidencing the examinee's justification and explanation skills.

12. The method of claim 10, wherein the one or more dimensions determine in the examinee response if:
a. proper objects identified;
b. a relationship between two or more objects; and
c. general statement provided to draw a conclusion or general support provided for a response statement.

13. The method of claim 10, wherein the one or more test items comprise constructed response test items.

14. The method of claim 10, further comprising:
summarizing in the output the response characteristic from the examinee response with the one or more dimensions for justification and explanation skills.

15. The method of claim 10, wherein the one or more dimensions and reference sets comprise feedback specific to the presence or absence of justification and explanation skills in the examinee response.

16. The method of claim 12, wherein the proper objects comprise one of a definition, theorem, formula, or axiom.

17. The method of claim 11, wherein the one or more test items comprise a constructed-response and the one or more dimensions determine in the examinee response:
a. a computation and reference to the computation;
b. a necessary step; and
c. a conclusion and support for an argument.

18. The method of claim 17, wherein the one or more dimensions determine in an examinee response if:
a. relevant properties and definitions support an argument;
b. a reason provided for the argument;
c. indirect proof or command of a counterexample to the argument demonstrated.

19. A method executing on a computing device for identifying justification and explanation skills in computer automated scoring of an examinee response, the method comprising:
providing a computing device having a non-transitory computer readable medium accessing:
a. one or more dimensions for measuring an examinee's justification and explanation skills;
b. one or more reference sets defining, at least in part, an attribute associated with the examinee's justification and explanation skills; and
c. one or more scoring metrics associated with the one or more dimensions for rating the examinee's justification and explanation skills;
storing one or more test items on the non-transitory computer readable medium;
administering to an examinee on the computing device the one or more test items;
receiving at the computing device the examinee response to the one or more test items;
comparing on the computing device the examinee response to the one or more test items with the one or more reference sets;
outputting from the computing device the one or more scoring metrics for the examinee response to the one or more test items, wherein the output includes a listing from the examinee response evidencing the examinee's justification and explanation skills;
annotating in the examinee response with the one or more reference sets for evidencing the examinee's justification and explanation skills.

20. The method of claim 19, wherein the one or more dimensions determine in an examinee's response if:
a. relevant properties and definitions support an argument;
b. a reason provided for use of the argument;
c. indirect proof or command of a counterexample to the argument demonstrated.

21. The method of claim 19, wherein the one or more test items comprise constructed response test items.

22. The method of claim 19, further comprising:
summarizing in the output the response characteristic from the examinee response with the one or more dimensions for justification and explanation skills.

23. The method of claim 19, wherein the one or more dimensions determine in the examinee response if:
a. proper objects identified;
b. a relationship between two or more objects; and
c. general statement provided to draw a conclusion or general support provided for a response statement.

24. The method of claim 19, wherein the one or more test items comprise a mathematical constructed-response and the one or more dimensions determine in the examinee response:
a. a computation and reference to the computation in an argument;
b. a necessary step in the argument; and
c. a conclusion and support for the argument.

25. The method of claim 19, wherein the one or more dimensions and reference sets comprise feedback specific to the presence or absence of justification and explanation skills in the examinee response.

26. The method of claim 19, further comprising:
training artificial intelligence on the computing device with one or more steps from the method.

27. The method of claim 23, wherein the proper objects comprise one of a definition, theorem, formula, or axiom.

28. The method of claim 19, wherein the one or more dimensions for measuring the examinee's justification and explanation skills are categorized into one or more skill levels.

29. The method of claim 28, further comprising:
assigning a skill level from the one or more skill levels based on the examinee's justification and explanation skills.
